(19) United States
(12) Patent Application Publication
(10) Pub. No.: US 2002/0032584 A1
(43) Pub. Date: Mar. 14, 2002

(54) Health care payment compliance management

(76) Inventors: Jonathan Doctor, Los Angeles, CA (US); Zima Hartz, Woodland Hills, CA (US)

Correspondence Address: George W Hoover, Esq., BLAKELY, SOKOLOFF, TAYLOR & ZAFMAN LLP, 12400 Wilshire Boulevard, Seventh Floor, Los Angeles, CA, 90025-1026, US

(21) Appl. No.: 09/833,089

(22) Filed: Apr. 10, 2001

Related U.S. Application Data
(60) Provisional application No. 60/196,050, filed on Apr. 10, 2000.

(51) Int. Cl. G06F 17/60

(52) U.S. Cl. 705/3

(57) ABSTRACT

A computerized system and method allows a health care practitioner treating a patient at a point of care to comply with a variety of rules and procedures. Compliance with the rules and procedures is required for payment approval by a health care payer such as a health maintenance organization (HMO) or other health insurer.

### CROSS REFERENCE TO RELATED CASE

This claims priority to and the benefit of U.S. Provisional Patent Application Ser. No. 60/196,050 filed Apr. 10, 2000, the entirety of which is hereby incorporated by reference.

### TECHNICAL FIELD

The present invention relates to a computerized system and method for the capture, processing, and management of health care related information for the purpose of expediting payment and complying with rules and procedures enforced by various health care third party payers.

### BACKGROUND INFORMATION

In the environment of health care today there is a great demand placed upon physicians and hospitals to handle large amounts of information, such as the data required for receiving payment approval from, for example, a health maintenance organization (HMO). A health care provider or practitioner is typically required to refer to code books or manuals provided by the HMO's and other insurance companies to determine how to properly report practitioner-patient encounters in order to receive payment approval from the HMOs or other health insurance companies.

These code books are often outdated, inaccurate, and extremely cumbersome to handle. Even if physicians are able to locate current and accurate information in the code books, the process is extremely time consuming and inefficient. As the patient load of physicians and other healthcare workers or staff has increased, it has become very difficult, to stay abreast of the various codes, rules, and procedures required to secure payment approval from the various different HMOs and other health insurance companies and health care payers.

The conventional approaches to other health care matters, such as record keeping, practitioner referrals, and health care testing, also present similar problems, in that it is difficult to identify current and accurate information on the requirements of the different HMO's and other health insurers and payers. Physicians are often effectively unable to ascertain which specialists accept which insurance carriers and to ascertain the details of testing requirements of insurance companies and other health care payers.

### SUMMARY OF THE INVENTION

The invention provides a computerized system, including a portable device and associated software, for use by health care practitioners including physicians, hospital staff, and other health care providers at the point of patient care. The portable device facilitates compliance with rules and procedures enforced by various health care insurers as a condition for payment approval for patient care and for affiliation with the particular health care insurer. The device enables a health care practitioner to perform appropriate actions and to capture and process information relevant to health care insurer rules and procedures while interacting with a patient during a practitioner-patient encounter.

In one embodiment, the invention is a system for facilitating compliance with rules and procedures required for payment approval from a health care payer in connection with an encounter between a health care practitioner and a patient. The system includes a portable device for use at a point of patient care by the health care practitioner.

The portable device includes memory for storing information that facilitates the health care practitioner's compliance with the rules and procedures required for payment approval from the health care payer in connection with the encounter, and includes input mechanism for receiving input from a user at least during the encounter and at the point of care; and an output mechanism for providing output to the user at least during the encounter and at the point of care and optionally includes a processor, where the information stored in the memory includes instructions for execution by the processor, and wherein the information also includes data that represents the rules and procedures required for payment approval from at least one health care payer in connection with the encounter.

The portable device enables the user to communicate to it a diagnosis, health care directive for the patient that includes drug medications and health care procedures to be applied to the patient and progress notes related information including category identification and voice or text commentary as applied to the patients health status.

The portable device responds to the communicated health care directive by communicating information to the user that constitutes notice that the health care directive violates compliance with at least one rule or procedure required for payment approval by a health care payer in association with the encounter.

The portable device enables the user to communicate a request for the portable device to calculate a visit level classification based at least upon one or more diagnosis's and health care directives and progress note related information input into the portable device.

The portable device includes a voice input mechanism that enables capture and storage of voice information regarding at least one category or issue associated with the encounter and enables the user to identify at least one category or issue associated with the encounter, and where the user can direct the portable device to store a portion of voice information in association with the at least one category or issue.

The user can communicate a query to the device for identifying remaining actions required for compliance with rules and procedures required for payment approval by a health care payer in association with the practitioner-patient encounter.

The device responds to the query by communicating at least one prompt to the user, the prompt communicating a directive for performing at least one action, and where the user responds to the at least one prompt by communicating information to the device representing or constituting the performance the at least one action.

The system can further include a computer connected to the portable device via a first communications channel, the computer receiving information generated by the portable device in connection with the encounter and a data store connected to the computer via a second communications channel, the data store receiving and storing information generated by the portable device in connection with the encounter.

In another embodiment, the invention is a method for facilitating compliance with rules and procedures required for payment approval from a health care payer in connection with an encounter between a health care practitioner and a patient. The method includes the steps of providing at least one portable device, the portable device for use at a point of patient care by the health care practitioner, the portable device including a memory for storing information that facilitates the health care practitioner's compliance with the rules and procedures required for payment approval from the health care payer in connection with the encounter and including an input mechanism for receiving input from a user at least during the encounter and at the point of care; and including an output mechanism for providing output to the user at least during the encounter and at the point of care.

In another embodiment the invention is a method for facilitating compliance with rules and procedures required for payment approval from a health care payer in connection with an encounter between a health care practitioner and a patient. The method includes the steps of receiving via a first communications channel, information generated by at least one portable device in connection with the encounter; storing the information generated by at least one portable device in connection with the encounter.

In another embodiment the invention is a method for facilitating compliance with rules and procedures required for payment approval from a health care payer in connection with an encounter between a health care practitioner and a patient. The method including the steps of providing at least one portable device, the portable device for use at a point of patient care by the health care practitioner, the portable device including a memory for storing information that facilitates the health care practitioner's compliance with the rules and procedures required for payment approval from the health care payer in connection with the encounter and including an input mechanism for receiving input from a user at least during the encounter and at the point of care; and including an output mechanism for providing output to the user at least during the encounter and at the point of care. The method also including the step of receiving via a first communications channel, information generated by the at least one portable device in connection with the encounter and storing the information generated by the at least one portable device in connection with the encounter.

Other features, aspects and advantages will become more apparent from the following description when taken in conjunction with the accompanying drawings.

### BRIEF DESCRIPTION OF THE DRAWINGS

The drawings are not necessarily to scale, the emphasis instead is placed on conveying the concepts of the invention:

FIG. 1 is a diagram illustrating components of a health care payment and compliance management system according to an embodiment of the invention.

FIGS. 2A-2C are diagrams illustrating the exterior features and internal components of a portable hand held device according to an embodiment of the invention.

FIGS. 4A-4D are a diagrams illustrating appointment and payer information portions of the portable device software user interface according to an embodiment of the invention.

FIGS. 5A-5D are a diagrams illustrating diagnosis selection portions of the portable device software user interface according to an embodiment of the invention.

FIGS. 6A-6F are a diagrams illustrating drug selection portions of the portable device software user interface according to an embodiment of the invention.

FIGS. 7A-7C are a diagrams illustrating visit classification selection portions of the portable device software user interface according to an embodiment of the invention.

FIG. 8 illustrates the type of information flowing between the portable device and the central data store components of the health care payment and compliance management system according to an embodiment of the invention.

FIG. 9 illustrates the type of information flowing to and from the billing and transcription service components of the health care payment and compliance management system according to an embodiment of the invention.

FIG. 10 is an diagram illustrating the execution of the checker program and the types and various sources of information resident inside of the central data store according to an embodiment of the invention.

### DESCRIPTION

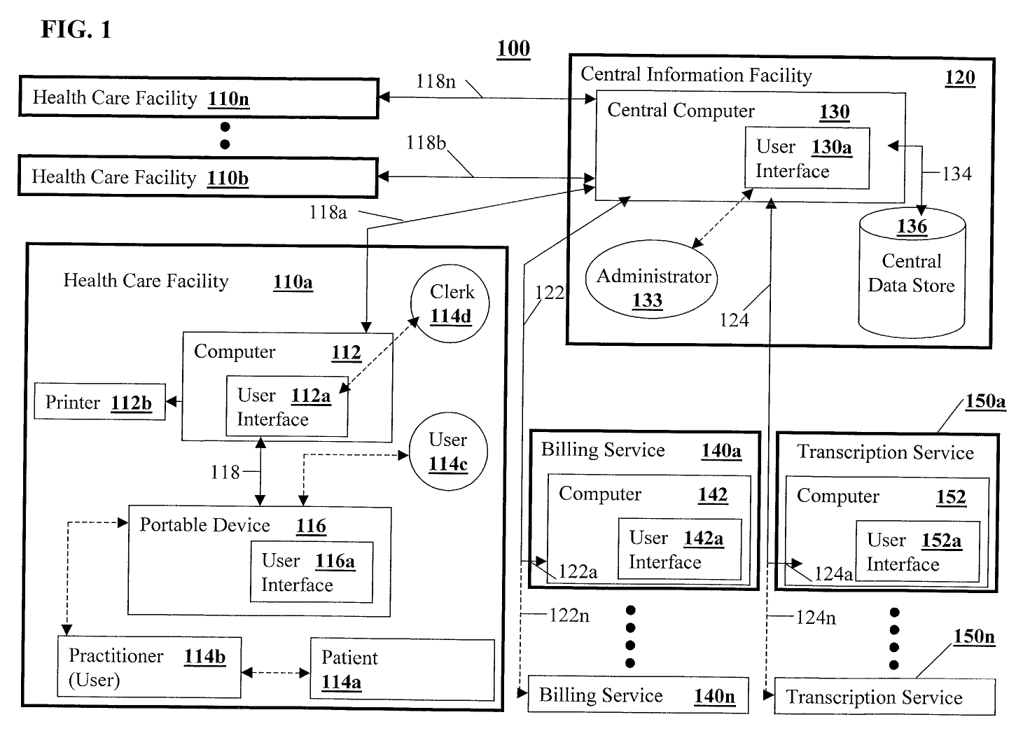

Referring to FIG. 1, one embodiment of a system 100 according to the invention is used to capture, store, and manage information associated with an encounter between a health care practitioner 114b (such as a physician) and a patient 114a at a health care facility 110a (such as the physician's office) or other location. Multiple facilities 110b-110n are shown, and each typically will include some or all of the hereinafter-described aspects of the facility 110a. The information associated with any encounter between the health care practitioner 114b and the patient 114a (for example, an office visit during which the practitioner 114b examines and/or diagnoses the patient 114a) includes information required for record keeping and required for ultimately obtaining payment approval from at least one health insurer, also referred to herein as a payer, associated with the patient 114a.

The health care practitioner 114b typically encounters or meets with the patient 114a within the vicinity of the health care facility 110a. The location of this encounter is also referred to as “the point of care.” or “place of service”. This location actually maps to a place of service code (POS) used for billing purposes. During the meeting, the practitioner 114b at least assesses a health concern of the patient 114a. The patient's health concern may be related to a minor or major or health problem. In accordance with the invention, a portable device 116 facilitates the performance of the practitioner's 114b responsibilities associated with the encounter.

The portable device 116 can be a hand held, notebook, laptop or any other type of small portable computer that can input, output, and process the types of information that are described herein, such as data required for record keeping including, for example, voice and data required for representing compliance with rules and procedures satisfying at least one health care insurer or payer. Theses rules and procedures include but are not limited to those required for payment approval or required to acquire or maintain affiliation with the health care payer.

Some health care payer required procedures involve requiring the practitioner 114b to provide particular information to the health care payer in a timely manner in order to ensure payment approval of payment for the patient encounter. Other health care payer required procedures may require the practitioner 114b to provide information to other parties, or to document his or her actions for later use during an audit, for example, by the health care payer, another health care authority or a government or law enforcement agency.

Each payment for an encounter by a health care insurer or payer is typically conditioned upon the completion of certain actions or procedures. These actions are typically performed by the entity or entities, for example, the practitioner who request a payment for work performed in an encounter. These actions can include providing certain encounter related information to the payer within a limited time period defined by the payer. For example, such actions could include providing information describing the diagnosis, the drug medication, and the medical procedures prescribed by the health care practitioner 114b for the patient during an encounter.

Such information may be required by each payer to be specified via a particular set of terminology and coding scheme and delivered to the payer in particular textual or data format. A payer may require the practitioner to provide information revealing the identity, health care specialty and affiliation of another practitioner that referred the patient 114a to the practitioner 114b, resulting in the encounter. Other payer required actions made include actions by parties other than the entity or entities requesting payment, such as by an independent medical testing facility.

Each payer can establish its own rules defining what procedures must be performed as condition for maintaining an affiliation with the payer or performed as a condition before payment will be approved. Some or all of these payer established rules 1082 can be adopted by a payer from another authority, such as Medicare 1081. The payer can add to or subtract from the requirements established by Medicare. These are referred to as exceptions. Payment associated with an encounter may not be entirely for actions occurring during the encounter. For example, services performed by a medical testing facility at the request of a practitioner during or in response to an encounter with a patient may be permitted to be payment approved and paid by a payer in association with the encounter.

The portable device 116 is portable in the sense that it allows the practitioner 114b easily to carry the device 116, by using one or both hands, to the location of one or more patients 114a (i.e., to one or more “points of care”). The patients 114a typically are waiting in separate examination rooms. Neither the practitioner 114b nor the patient(s) 114a need to travel to the location of the device 116. The practitioner 114b and/or another person or persons 114c (such as the practitioner's 114b assistant or a nurse) can directly use the device 116.

The device 116 provides a user interface 116a that includes an input and an output mechanism. The input mechanism, including for example a keyboard, touch sensitive display screen, pointing device, voice recording Dictaphone or trackball enables the user 114b, 114c to communicate information to the device 116. The output mechanism, including for example a touch sensitive display screen, voice, sound or vibration generator, enables the device 116 to alert or communicate information to the user 114b-c.

The computer 112, located within the health care facility, provides a user interface 112 and communicates with another computer 130 typically located at a central information facility 120 via another communications channel 118a. The other health care facilities 110b-110n also communicate with the central computer 130 via communications channels 118b-118n respectively. Typically, some or all of the health care facilities 110a-110n are located remotely from the centralized health care information facility 120. Consequently, the communications channels 118a-118n are more likely to involve the use of longer range communications mechanisms such as wide area computer networks including the Internet. In one disclosed embodiment, the Internet is the computer network linking the individual computers 112 at the various health care facilities 110a-110n to the central computer 120.

The computer 112 provides a user interface 112a for interaction with a user of the computer 112, referred to in FIG. 1 as a clerk 114d. An Internet browser program can provide a user interface for communicating over the Internet network. The clerk 114d could be the practitioner 114b or any other user 114c of the portable device 116 but more typically will be an administrative office worker at the facility 110a.

The computer 130 has input/output access to a central data store 136, typically located at the central information facility 120. In one disclosed embodiment, all of the communications channels 118a-118n, 122a-122n and 124a-124n are Internet communications paths, although other types of network connections are possible.

The central data store 136 stores information associated with a plurality of the patients 114a, practitioners 114b, health care facilities 110a-110n, billing service facilities 140a-140n, transcription service facilities 150a-150n and health insurance companies or payers. Health care payer associated information includes rules and procedures from a variety of health care payers regarding the requirements for maintaining an affiliation with the payer or for receiving payer payment approval for any particular health care practitioner-patient encounter. These rules and procedures can be populated into the central data store 136 manually or electronically via a secure access mechanism 134, by central information facility personnel, by one or more of the billing service providers 140a-140n or directly from one or more health insurers, for example.

The central data store 136 can be implemented from a variety of non-volatile data storage hardware, such as hard disks, read-only and write enabled CD ROMS, tape or the like. Software such as commercial database software such as sold by Oracle or Sybase for example, or custom developed software can be utilized to interface the data store 136 to software executing on the central computer 130 and to structure some or all of the contents of the data store 136 in a particular way.

The computer 130 can communicate with at least one billing service provider 140a and with at least one transcription service provider 150a via communications channels 122a and 124a, respectively. Typically, a billing service 140a-n is associated with one or more health care payers and patients affiliated with those one or more payers. The billing service actually converts portable device generated encounter forms 841 (not shown) into bills delivered to the payer. These encounter forms 841 are generated and communicated to the billing service 140a-n by the system 100. Typically, a transcription service 150a-n is associated with one or more health care facilities 110a-n or practitioners 114b. The transcription service actually converts portable device generated voice files (“WAVE” formatted files) 842, and transcription requests 843 into transcription files 980 containing the translated text data and communicates the text data back to the central data store 136 for storage as encounter related records.

The billing service 140a makes use of a computer 142 providing a user interface 142a. The transcription service 150a also makes use of a computer 152 providing a user interface 152a. In some embodiments, either the billing service 140a, the transcription service 150a or both are provided secure access to a portion of the information residing inside the central data store 136. This access can be provided via the Internet where each user interface 142a and 152a employs an Internet browser to allow authorized billing sand transcription service personnel secure access to a portion of the contents of the data store 136.

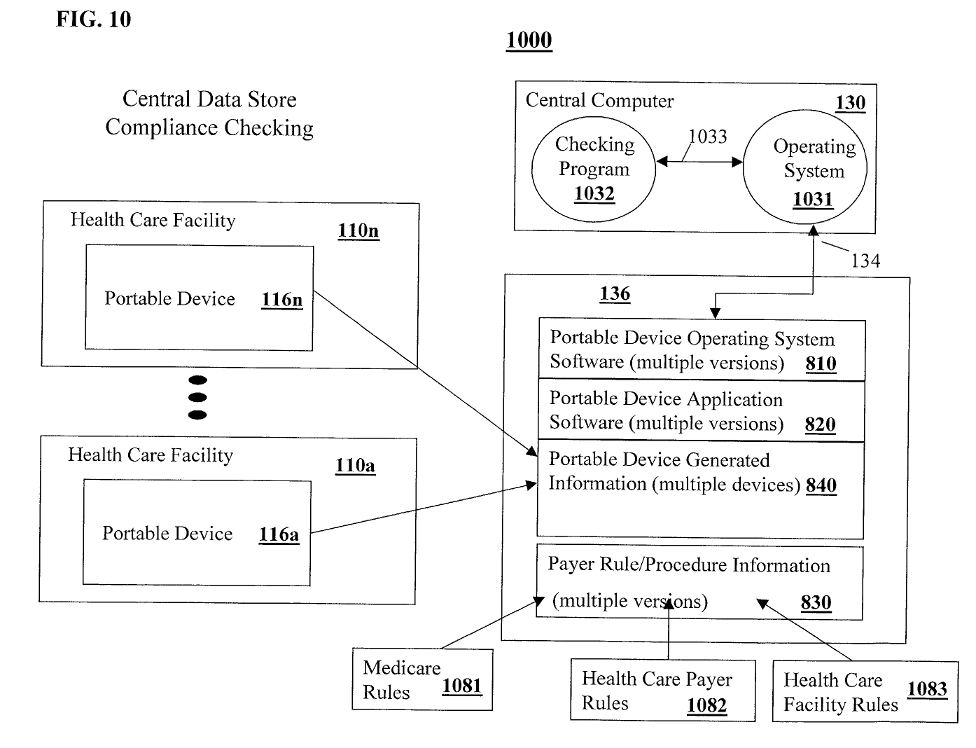

Health care payer payment rules and procedures are subject to change and can be revised according to a schedule, on demand, with or without notice. The health care information data store 136, and the device 116, are adapted to receive revised updates of the health care payer payment rules and procedures (FIG. 10). These updates can be communicated to the data store electronically or manually. A billing services 122a-122n typically provides updates to payment rules and procedures 1081 and 1082 of payers associated with that particular billing service 122a-n.

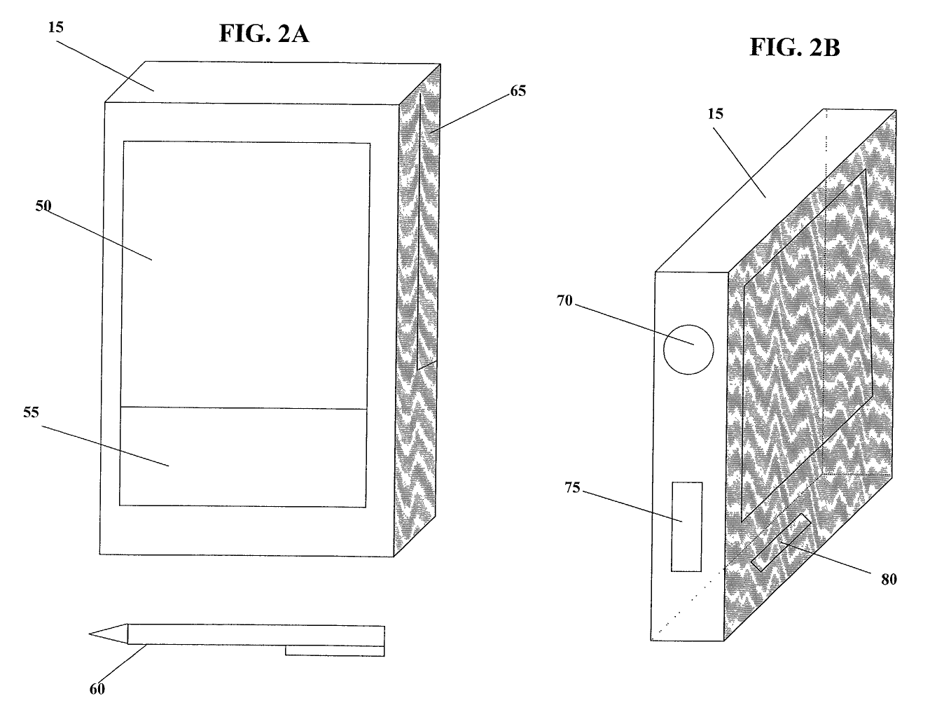

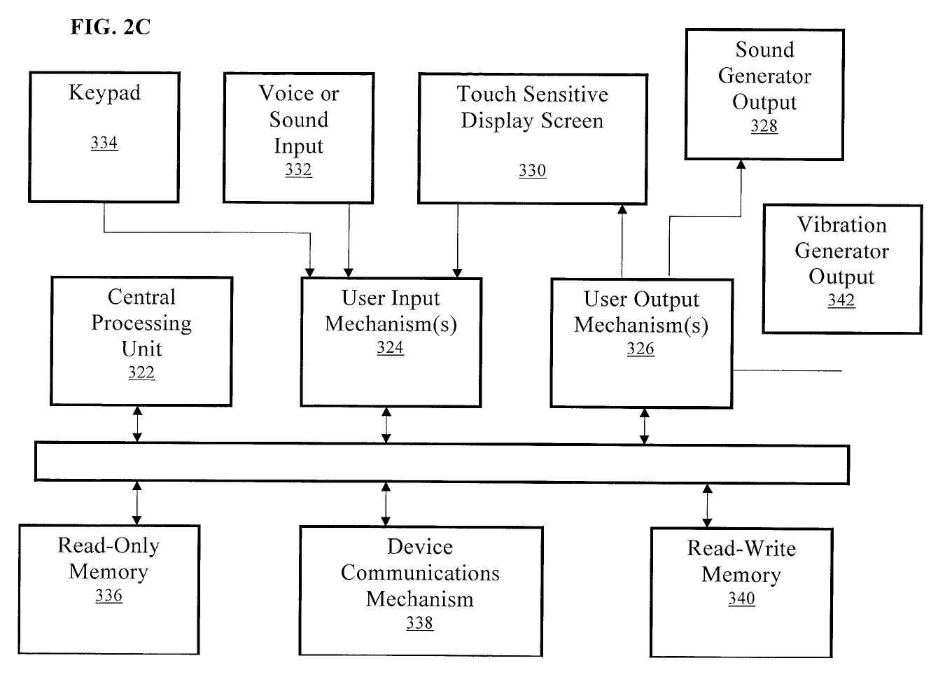

Referring to FIGS. 2A and 2B, the hand-held device 315 externally includes a touch-sensitive screen display 350a and 350b for viewing encounter related information, a stylus 360, which is used in conjunction with the touch-sensitive screen to communicate information including commands to the device 315, a stylus storage compartment 365, device communications mechanisms including an infrared port 375 for communicating with a printer and an interface port 380 for communicating with a computer such as the health care facility computer 112a, and a power button 370. The hand-held device 315 internally includes at least a microprocessor and memory for storing encounter related information including information associated with multiple patients and multiple health care payers.

Optionally, a hand held device could also provide additional user input mechanisms such as a keypad (not shown), a Dictaphone or microphone for voice or sound input (not shown) or a track ball (not shown). The hand held device could also provide additional user output mechanisms such as a sound generator (not shown) to alert the user when the device is stored within hearing distance of the user or a vibration generator (not shown) to alert the user when the device is stored in contact with the user's body.

In one embodiment the touch sensitive screen 350a and 350b can be apportioned, into two or more separate windows for displaying different collections of information. The lower approximately one third of the touch-screen 350b of the hand-held device 315 illustrates the size and location of a separate window, sometimes referred to as a message window 350b. The line separating the windows 350a and 350b represents the location of a line of pixels and does not represent any physical barrier between the windows 350a and 350b. This message window 350b can be used to display additional information related to an item displayed in the upper portion of the screen 350a. This window 350b can display a touch sensitive keyboard as one user input mechanism.

FIG. 2C illustrates types of internal hardware components feasible to reside inside the hand held device 315. All components communicate with each other through at least one system bus 320. A central processing unit (CPU) 322 and memory 336 and 340 are directly connected to the system bus 320. Central processing unit instruction information, also referred to as firmware or software, can be stored inside the read-only memory 336 and the read-write memory 340. The CPU accesses or fetches the contents of either type of memory via the communication of the stored software information through the system bus 320.

Read-only memory (ROM) 336 is typically of the non-volatile type, meaning that it requires no constant power to preserve the information content of its memory for later use. This type of memory typically stores “bootstrap” software which is the first type of software to execute upon powering the device to the ON state via the power button 370. Read-write memory 340, is typically of the volatile type, meaning that it requires constant power to preserve the information content of its memory for later use. This type of memory is commonly referred to as random access memory (RAM) and it typically stores the bulk of the software and data directly accessible CPU.

The CPU 322 controls at least one user input mechanism 324, at least one user output mechanism 326 and at least one device communications mechanism 338 via communication of command and status information via the system bus 320. The user input mechanism 324 can receive user communicated information from a variety of sources including but not limited to a touch sensitive display screen 330, a keypad 334 or a voice or sound input component such as a Dictaphone or microphone 332. The user output mechanism 326 can communicate information to the user in a variety ways including but not limited to a display screen 330 of either the touch sensitive or non-touch sensitive variety, a sound generator 328 or vibration generator 342 or track ball (not shown) component. The sound generator 328 enables the device 315 to alert the user when the device is stored within the hearing distance of the user. The vibration generator 342 is used to alert the user when the device is stored in contact with the user's body.

The device 116, using its device communications mechanism 338 as an input/output mechanism, can communicate with another computer, such as a desktop computer 112 (located, for example, within the health care facility 110a) over a communications channel 118. The communications channel 118 can be any connection that enables the device 116 to exchange information with the computer 112. Such connections can include, but are not limited to, the use of portable memory modules such as flash memory storage cards, a device docking station or cradle, a cable connection (supporting, for example, some communications protocol such as RS-232, IEEE-488 or other network or point to point protocol communications interfaces), a wireless connection including an infrared port 375.

One embodiment of the hand-held device 315 for accommodating the application software of the present invention is a Windows CE palm-size personal computer, such as the Casio Cassiopeia E-125 from Casio Inc. of Dover N.J. A Compaq IPAQ H3600 hand held device or other portable computing unit executing the Windows CE 3.0 operating system is capable of accommodating the encounter software program described herein. Other small, hand-hand held, portable computing devices could be used as the hand-held device 315, and other operating systems could be used instead of Windows CE which is available from Microsoft Corporation. A commercial embodiment of a system according to the invention is available from Parkstone Medical Information Systems, Inc. and referred to as SmartEncounter Charge Capture system. The SmartEncounter system uses the Casio Cassiopeia E-125 running Windows CE as the hand-held device 315 for executing the encounter software program.

FIGS. 3A-3D, 4A-4D, 5A-5D, 6A-6D and 7A-7D illustrate a series of user interface screens describing an embodiment of the invention. In this embodiment, the application software program named “Encounter” 820 executes on a hand held portable device 116 supporting the Microsoft Windows CE operating system and exchanges information with a user through a series of user interface screens.

FIG. 3-A illustrates the Programs screen 210 which displays icons each representing a particular software application executing on this hand held device platform. In this embodiment, each health care practitioner is separately assigned a portable device. The device used in this embodiment is assigned to the user named “Dr. Smith”. Access to the Programs Screen 210 is password protected and restricted to a password known only by Dr. Smith. Previous to the display of the Programs Screen 210, Dr. Smith successfully passed through the password mechanism (not shown) of this device to display the Programs screen. The icon titled “Encounter” 212 represents the software application implementing this embodiment of the invention. The user selects the “Encounter” icon 212 to initiate execution of the Encounter software application.

FIG. 3-B illustrates the Appointments Screen 220 which is the initial displayed screen of the Encounter software application. Each named patient name listed below a date represents a scheduled appointment or encounter for that named patient with Dr. Smith on that date. For example, the named patient “Bob Lewis” 221 is listed as having an appointment with Dr. Smith on the date “Dec. 15, 2000” 222. Selecting a named patient listed below a date displays an Encounter screen associated with a scheduled appointment or encounter for that named patient with “Dr. Smith” on that date. The user selects the named patient “Bob Lewis” which is temporarily highlighted and listed below “Dec. 15, 2000” to display the Encounter screen associated with that scheduled encounter.

FIG. 3-C illustrates the Encounter Screen 230 which is displayed upon selecting an appointment represented by a named patient, “Bob Lewis”, listed below the date “Dec. 15, 2000” 222 from the Appointments screen of FIG. 2-B. The Encounter screen 230 lists the folder names for the folders Diagnosis 232, Drugs 234, Visit Classification 236 and Payer Information 238 associated with the encounter patient, “Bob Lewis”. The user can choose to open any of the listed folder names by selecting a folder name from this screen. The user selects the Payer Information folder name 238 which is temporarily highlighted on the Encounter screen 230 to display the Payer Information screen 240.

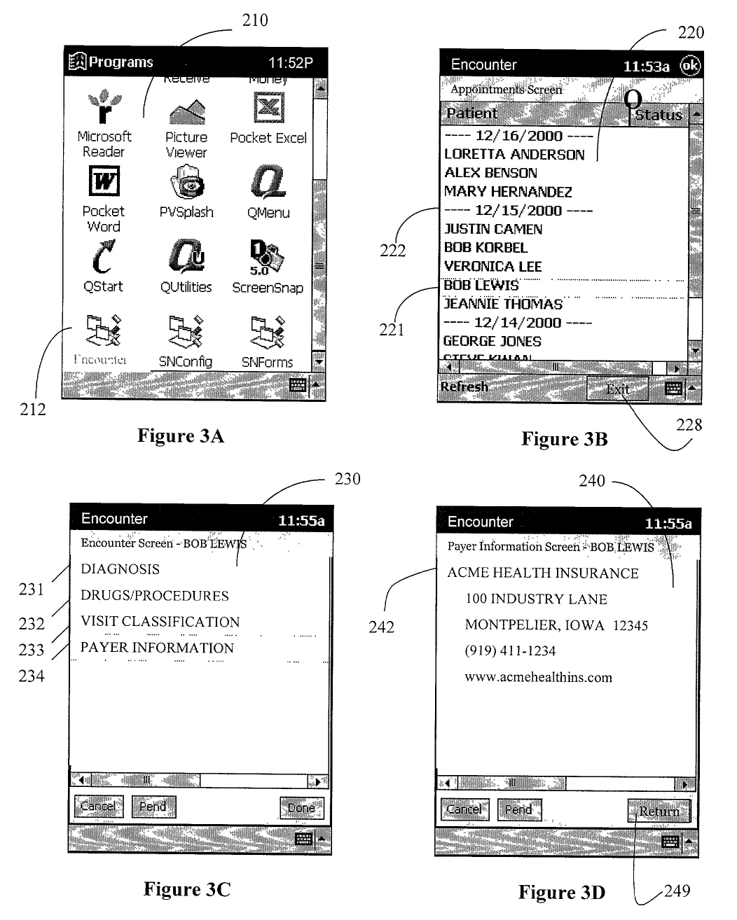

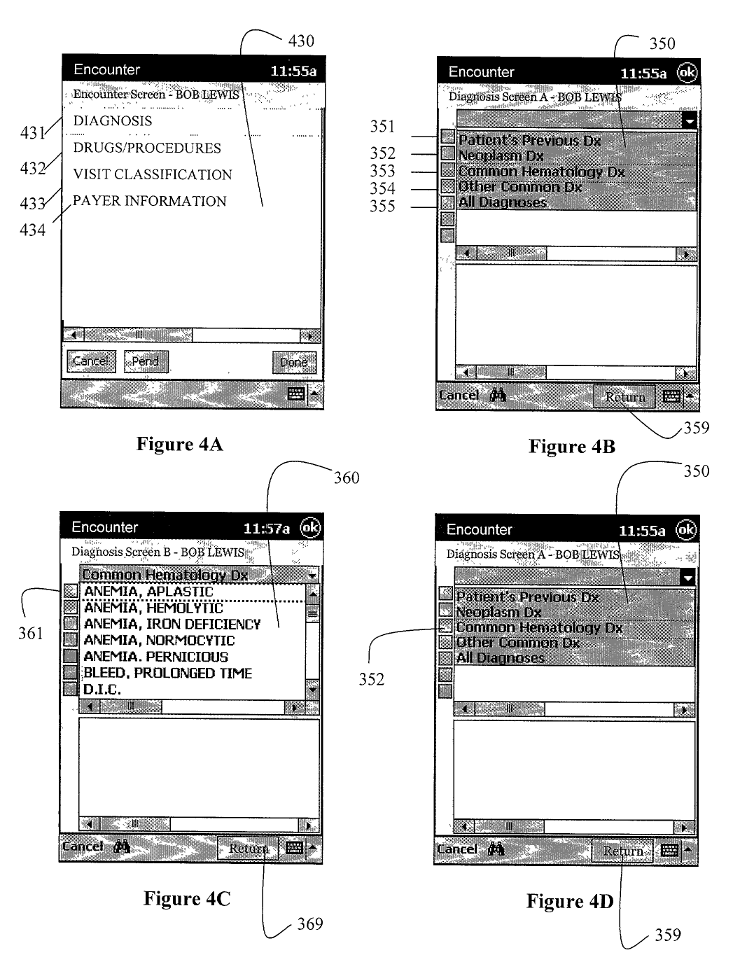

FIG. 3-D illustrates the Payer Information screen 240 which is displayed upon selecting the Payer Information folder name 238 listed on the Encounter screen 230 of FIG. 2C. The Payer Information screen 240 lists the name, address and contact information 242 associated the health insurer or payer associated with the encounter patient, “Bob Lewis”. The user selects the Return Button 249 which returns the user interface to display the Encounter screen 230 and 330 as illustrated in FIG. 3-C and FIG. 4-A.

FIG. 4A illustrates the Encounter screen which is displayed as a result of the user selecting the Return Button 249 located on the Payer Information screen of FIG. 3-D. The Encounter screen 430 lists the names for the folders Diagnosis 431, Drugs 432, Visit Classification 433 and Payer Information 434 associated with the encounter patient, “Bob Lewis”. The user can choose to open any of the listed folders by selecting a folder name from this screen. For example, the user selects the Diagnosis folder name 431 which is displayed on the Encounter screen 430. As a result of this user selection, the Diagnostic folder name 432 is temporarily highlighted as indicated before the display of the Diagnosis screen as shown in FIG. 4B.

FIG. 4B illustrates the Diagnosis Screen-A 350 which is displayed as a result of the user selecting the Diagnosis folder name 432 listed on the Encounter screen 330 of FIG. 4A. The Diagnosis screen lists the names of folders, “Patients Previous Dx” 352, “Neoplasm Dx” 354, “Common Hematology Dx” 356, “Other Common Dx” 358 and “All Diagnoses” 360 each representing a grouping of diagnosis (Dx) names. The user can choose to open any of the listed folders by selecting a folder name from this screen. For example, the user selects the Common Hematology Dx folder name 356 which is temporarily highlighted as indicated. As a result various diagnosis names stored inside the Common Hematology Dx folder 356 are listed as shown in FIG. 4-C.

FIG. 4-C illustrates the listing of Diagnosis Screen-B 360 various diagnosis names “Anemia, Aplastic”, “Anemia, Hemoytic”, “Anemia Iron Deficiency”, Anemia, Normocytic”, “Anemia, Pernicious” stored inside the Common Hematology Dx folder 356 which was opened from the Diagnosis Screen-A 356. The user can choose to select one or more diagnosis names listed by selecting one or more diagnosis names listed on this screen 360. For example, the user selects the “Anemia, Aplastic” diagnosis name 361 which is listed on this screen. As a result of this selection, the “Anemia, Aplastic” diagnostic name 361 is temporarily highlighted as indicated. This action results in the selection of the “Anemia, Aplastic” diagnostic name as at least one diagnosis made for the patient “Bob Lewis” during this encounter. The user can un-select or toggle off the selected and highlighted Anemia, Aplastic diagnostic name by re-selecting it when it is highlighted and selected. The user presses the Return Button 369 which stores the selection of the “Anemia, Aplastic” diagnosis name and returns the user interface to display the Diagnosis Screen-A 350 as illustrated in FIG. 4D.

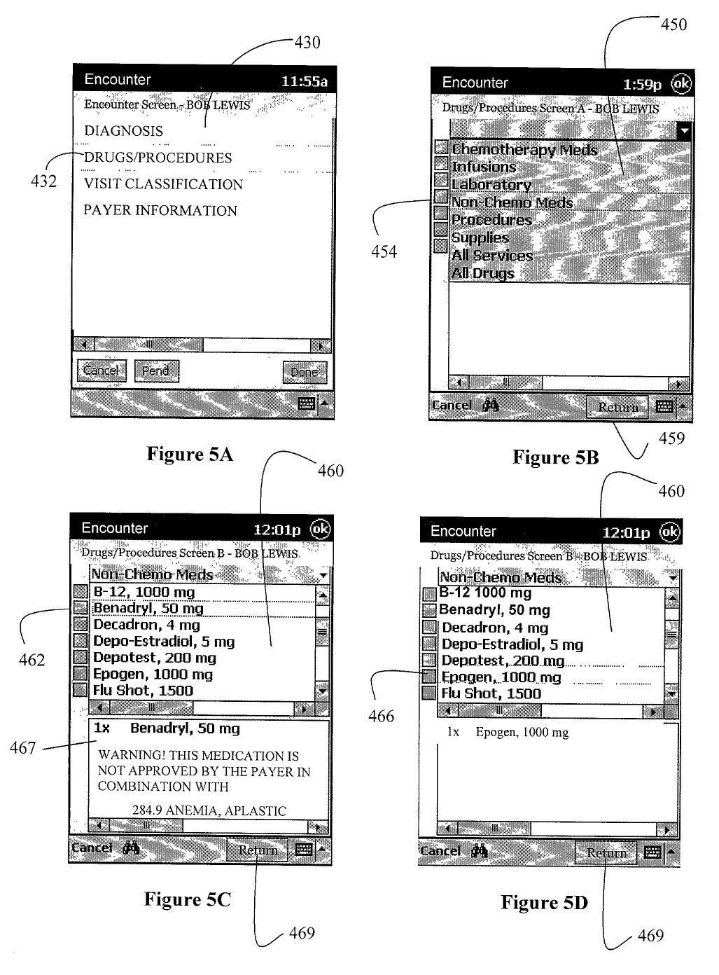

FIG. 4D illustrates the Diagnosis Screen A 350 which is displayed as a result of the user selecting the Return button 369 displayed with the Diagnosis Screen-B 360 of FIG. 4C. The Diagnosis Screen-A 350 lists the names of folders, each representing a grouping of diagnosis (Dx) names, as discussed in FIG. 4B. The user can choose to open any listed folders, for example a folder other than “Non-Chemo Meds” by selecting a folder name from this screen. The user elects not to select any other drugs and presses the Return Button 359 which records the selection of the “Anemia, Aplastic” diagnosis name made in Diagnosis Screen-B 360 of FIG. 4C and returns the user interface to display the Encounter screen 430 as illustrated in FIG. 5A.

International Classification of Disease Codes (ICD-9 Codes) represent a standard coding schema for classifying diseases. Common Procedural Terminology (CPT) classifies medical or health care procedures via procedure codes. Drugs and supplies are classified by (HCPCS) codes. These can be used by the software for representing a physician decided diagnosis, drug prescription or application and procedures.

FIG. 5A illustrates the Encounter screen which is displayed as a result of the user selecting the Return Button 359 located on Diagnosis Screen-A of FIG. 4D. The user selects the “Drugs /Procedures” folder name 432 which is displayed on the Encounter screen 430. As a result of this user selection, the Drugs/Procedures folder name is temporarily highlighted as indicated and the Drugs/Procedures Screen-A as shown in FIG. 5B.

FIG. 5B illustrates the Drugs and Procedures Screen-A 450 which is displayed as a result of the user selecting the Drugs and Procedures folder name 432 listed on the Encounter screen 430 of FIG. 5A. The Drugs and Procedures Screen-A 450 lists the names of folders, each representing a grouping of drugs, supplies, and procedures. The user can choose to open any of the listed folders by selecting a folder name from this screen 450. For example, the user selects the “Non-Chemo Meds” folder 454 name which is temporarily highlighted and displayed on the Drugs and Procedures screen 450 to list various drug (medication) names stored inside the “Non-Chemo Meds” folder 454 as shown in FIG. 5C.

FIG. 5C illustrates the display of the Drugs and Procedures Screen-B 460 which lists various drug names stored inside the Non-Chemo Meds folder 454 which was opened from the Drugs and Procedures Screen-A 450. The user can choose to select one or more drug names listed on this screen. For example, the user selects the “Benadryl, 50 mg” drug name which is listed on this screen 460. As a result of this user selection, the “Benadryl, 50 mg” drug name 462 is highlighted as indicated.

In response to this selection, the Encounter software application program 820 displays a warning 467 with the following text “WARNING: THIS MEDICATION IS NOT APPROVED BY THE PAYER IN COMBINATION WITH 289.4 ANEMIA, APLASTIC”.

The user can elect to un-select the “Benadryl, 50 mg” drug by re-selecting and untoggling the highlighted drug name Or the user can elect to select one or more other drug names other than “Benadryl, 50 mg” listed on this screen 460. FIG. 5D illustrates the user selecting “Epogen, 1000 mg” drug name 464 from the Drugs/Procedures-Screen-B 460 as a alternative to the “Benadryl, 50 mg” 462 selection not approved by the payer. Having finished making all drugs name selections below the” folder name 432, the user then presses the Return Button 469 which records the selection of the “Epogen, 1000 mg” 466 from the “Non-Chemo Meds” folder 454 and returns the user interface to display the Drugs/Procedures Screen-A 450 as illustrated in FIG. 5E.

FIG. 5D illustrates the user selecting “Epogen, 1000 mg” drug name 466 from the Drugs/Procedures Screen-B 450 as a alternative to the “Benadryl, 50 mg” 462 selection not approved by the payer. Having finished making all drugs name selections below the “Non-Chemo Meds” folder name 454, the user then presses the Return Button 459 which records the selection of the “Epogen, 1000 mg” 466 from the “Non-Chemo Meds” folder 454 and returns the user interface to display the Drugs/Procedures Screen-A 450 as illustrated in FIG. 5E.

FIG. 5E illustrates the Drugs/Procedures Screen-A 450 which is displayed as a result of the user selecting the Return Button 469 located on Diagnosis Screen-B 460 of FIG. 5D. The user having completed all drugs name selections within the “Drugs/Procedures” folder name 432, the user again presses the Return Button 459 which records the selection of the “Epogen, 1000 mg” 466 from the “Non-Chemo Meds” folder 454 and returns the user interface to display the Encounter Screen 430 as illustrated in FIG. 5F.

FIG. 5F illustrates the re-display Encounter screen 430 as a result of the user selecting the Return Button 459 located on Drugs/Procedures Screen-A 450 of FIG. 5E.

The warning of FIG. 5C notifying the user that the drug medication “Benadryl, 50 mg” is not NOT APPROVED BY THE PAYER IN COMBINATION WITH 289.4 ANEMIA, APLASTIC” was the result of the encounter software program processing payer rule and procedure information supplied to the device. The payer rule/procedure information can be encoded as software readable data that represents payment approval compliance rules specified by the payer. These payment approval compliance rules can be represented as a set of relationships between a diagnosis and a heath care directive by the practitioner. The health care directive can include for example, the prescription of drug medication or health care procedure to be applied to the patient.

In one embodiment, these relationships between possible diagnosis's, possible prescribed drug medications and/or prescribed procedures can be represented by the contents of a table, referred to as a rule table. A rule table can contain payment compliance rules associated with one entity, for example a health care payer or government agency, such as Medicare. Some or all of the payment compliance rules associated with a health care payer can be adopted by that payer from another authority, such as Medicare. The payer can adjust adopted rules by adding to or subtracting from the base rule requirements established by Medicare. These are referred to as payer specific rule exceptions. Positive exceptions are more permissive and less restrictive relative to the adopted base rules. Negative exceptions are more restrictive relative to the adopted base rules.

In one embodiment, a rule table is associated with a payer. The rule table is a matrix of cells. Each row is defined by series of cells where each cell residing in the row resides in a separate column. Each column is defined by a series of cells where each cell residing in the column resides in a separate row. Each row of the rule table represents a possible prescribed drug medication for a patient associated with the payer. Each column of the rule table represents a possible diagnosis for the patient for a patient associated with the payer. The intersection of each row and column of the rule table identifies a single cell residing in one row and one column. Information placed in this cell can represent the relationship between the drug medication represented by the intersecting row and the diagnosis represented by the intersecting column.

For example, the value of “1” stored in this cell can represent that prescribing the drug medication represented by the intersecting row is permissible for the diagnosis represented by the intersecting column according to the rules of the payer associated with this rule table. Alternatively, a value of “0” stored in this cell would represent that prescribing the drug medication represented by the intersecting row is NOT permissible for the diagnosis represented by the intersecting column according to the rules of the payer associated with this rule table.

When a payer adopts rules from another entity, then the payer rule table could be interpreted as an exception rule table, that is interpreted relative to the rule table from the other entity from which rules are adopted. An exception rule table typically only contains information that differs from the adopted base rule table. For example, a value of “1” stored in a cell representing a diagnosis-drug medication pair in the exception rule table, represents a permissive relationship between the diagnosis-drug medication pair that differs from the rule of the base rule table. Alternatively, a value of “0” stored in a cell representing a diagnosis-drug medication pair in the exception rule table, represents a NONE permissive relationship between the diagnosis-drug medication pair that differs from the rule of the base rule table. A value of “2” stored in a cell representing a diagnosis-drug medication pair in the exception rule table, represents that the relationship between the diagnosis-drug medication pair is the same as that found in the base rule table. The base rule table can then be searched to determine whether the relationship is permissive or NOT permissive.

Rule tables can represent relationships between diagnosis's and health care procedures, between drug medication and health care procedures, between practitioners-and affiliated payers, between practitioners and patients, between appointments, patients and practitioners and so forth. Many health care compliance rules can be modeled via one or more rule tables. Rule tables can be combined to show relationships between more than two entities. For example, a first rule table could relate appointments to patients, a second rule table could relate appointments to practitioners and the combination of the first and second rule table could relate patients and practitioners to common appointments and so forth.

Rule tables can be implemented as one or more spreadsheets, such as those provided by the Microsoft Excel product or as one or more database tables such as provided by the Microsoft SQL, Oracle or Sybase database products. Database tables can be combined or joined by data base provided software to reveal relationships between different rule tables and to reveal relationships between the entities that each table relates, such as between a table that relates appointments to patients and another table that relates appointments to practitioners. The combination of these two tables for example, reveals the relationship between practitioner's and patient with respect to appointments.

The portable device can enable a practitioner to input separate collections of voice information via a microphone 332. These separate collections or portions of voice information can be stored into one or into separate voice or “Wave files” 842. The practitioner can tag or associate a category or issue describing the patient's health status with a separate portion of voice information, store in a voice file 842. These categories or issues can be expressed as text entered into the device 116a from a touch screen keyboard or from selection of issue from a list displayed on the device 116a.

These tagged voice files 842 can collectively contain some or all of what is referred to as the practitioner's progress notes concerning the patient's visit and health status. The contents of these progress notes can be categorized according to Medicare's mandated documentation requirements. The health care financing administration (HCFA) describes standard categories for documenting specific findings identified during an encounter. HCFA provides guidelines outline an algorithm for determining a visit level based on what is identified in these standard categories. The system calculates the visit classification based upon this algorithm.

In one embodiment, the encounter software program can provide list of progress notes related categories or issues compliant with HCFA guidelines to be selected by the practitioner. These categories, issues or items can be “specialty specific” (e.g cardiology, orthopedics, etc.) and the categories they fall within can be Medicare mandated. Medicare mandated categories are often required for payment by third party health care payers. Health insurance companies typically follow rules set by Medicare.

Categories, also referred to as issues or items, are selected by checking or selecting choices provided to the user in templates (not shown). Templates can contain user interface components including but not limited to text entry boxes, check boxes, push buttons etc. These categories can include Chief Complaint, History of Present Illness, Review of Systems, Medical Decision Making etc. The practitioner can select categories that are negative or do not apply to the health status of the patient and can otherwise elect to input voice commentary associated with a subset of these categories that do apply to the health status of the patient. Transcription request files 843 aid in associating the voice files 842 with the progress notes related categories.

After completing the encounter, these voice files 842 and associate transcription requests 843 are then communicated to the data store 136 via the central computer 130 and the health care delivery computer 110a. From the data store 136, these voice files 842 and transcription requests 843 are delivered to a transcription service 150a-150n, via the central computer 130 and the communications channel 124, for example via an Internet Web site located on the central computer 130.

The transcription service 150a-150n translates the voice files 842 into text files, referred to as transcription files 980 and then transmits the transcription files back to the central computer 130 for storage into the data store 136. The practitioner located at the health care facility can access these transcription files 980 and either print them as paper records for storage into the patient's health care chart, or allow these forms 980 to remain on-line accessible from the data store 136 via the central computer 130a. The central computer 130 can provide an Internet Web site for access to these forms.

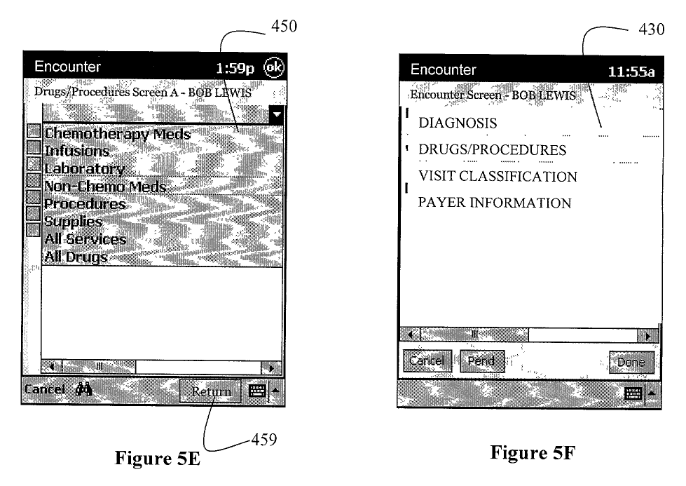

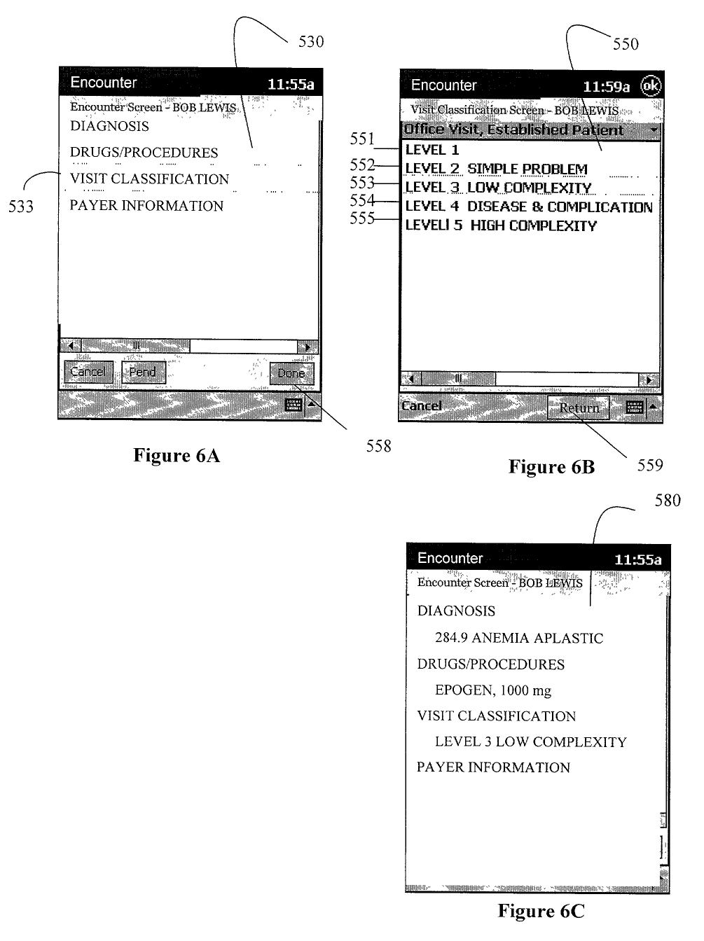

FIG. 6A illustrates the Encounter screen 530 which is displayed as a result of the user selecting the Return Button 459 located on Drugs/Procedures Screen A 450 of FIG. 5F. The user selects the “Visit Classification” folder name 533 which is displayed on the Encounter screen 530. As a result of this user selection, the “Visit Classification” folder name 533 is temporarily highlighted as indicated and the Visit Classification screen is displayed as shown in FIG. 6B.

FIG. 6B illustrates the Visit Classification Screen 550 which is displayed as a result of the user selecting the Visit Classification folder name 533 listed on the Encounter screen 530 of FIG. 5-A. The Visit Classification Screen 550 lists the names of various visit classification names “LEVEL 1” 551, “LEVEL 2 SIMPLE PROBLEM” 552, “LEVEL 3 LOW COMPLEXITY” 553, “LEVEL 4 DISEASE & COMPLICATION” 554 and “LEVEL 5 HIGH COMPLEXITY” 555. The visit classification chosen affects the payment amount a payer will approve. Typically, a payer will approve larger payments for a “LEVEL 5 HIGH COMPLEXITY” 555 visit classification than for “LEVEL 2 SIMPLE PROBLEM” visit classification.

The user selects the “LEVEL 3 LOW COMPLEXITY” 553 visit level calculation which is highlighted. Having completed the visit level classification selection, the user selects the Return button 559 which records the selection of the “LEVEL 3 LOW COMPLEXITY” from the “Visit Classification” folder 533 and returns the user interface to display the Encounter Screen 530 as illustrated in FIG. 5-C.

In one embodiment, the system will automatically calculate the visit classification based upon previous user selected diagnosis names, drugs, procedures made in association with the encounter and based upon progress notes, the issues or categories identified in association with voice input via dictation into the device. These progress notes can be categorized according to Medicare's mandated documentation requirements. The health care financing administration (HCFA) describes standard categories for documenting specific findings identified during an encounter. HCFA provides guidelines that outline an algorithm for determining a visit level based on what is identified in these standard categories. The system calculates the visit classification based upon this algorithm and stores the result in an associated encounter form.

In another embodiment, the user can manually elect to select a “LEVEL CALCULATE” visit classification button (not shown) which would perform the previously described automatic calculation upon user demand to determine an appropriate visit classification as described for the automatic calculation described previous to this embodiment.

FIG. 6C illustrates an alternative Encounter screen 580 which is displayed as a result of the user selecting the Return Button 559 located on the Visit Classification of FIG. 6B. The user now having completed all diagnosis name selections below the “Diagnosis” folder name 431, and having completed all drug and procedure name selections below the “Drugs/Procedures” folder name 432, and having completed the visit classification selection 533 below the “Visit Classification” screen 550, the user elects to select the Done button 558 completes the encounter for “Bob Lewis”.

Upon selecting the Done button 558, the Encounter software application records the selection of the “Anemia, Aplastic” diagnosis name selection from the “Diagnosis” folder name 231 and records the “Epogen, 1000 mg” drug name from the “Non-Chemo Meds” folder 432 and records visit classification name from the “Visit Classification” folder. The user interface then returns to display the Appointment Screen 520 as illustrated in FIG. 6D.

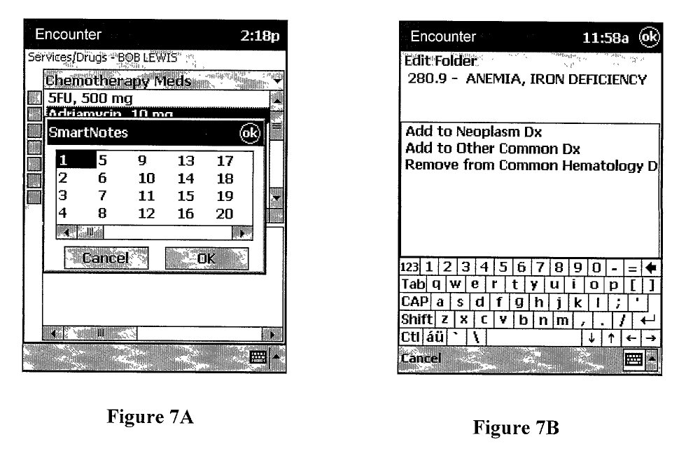

FIG. 7A illustrates a Drug Quantity popup screen 580 used to further specify the quantity of the selected drug if different that the quantity listed with the drug in the Drugs/Procedures Screen-B 460. This popup screen displays when the user selects the quantity text displayed next to the drug name. A popup screen or window is displayed over and above existing information displayed on the screen. When the popup screen or window is un-displayed, the existing information displayed on the screen just before the popup window was displayed, is re-displayed as before the display of the popup window.

FIG. 7B illustrates a keyboard in the message window of the touch sensitive screen.

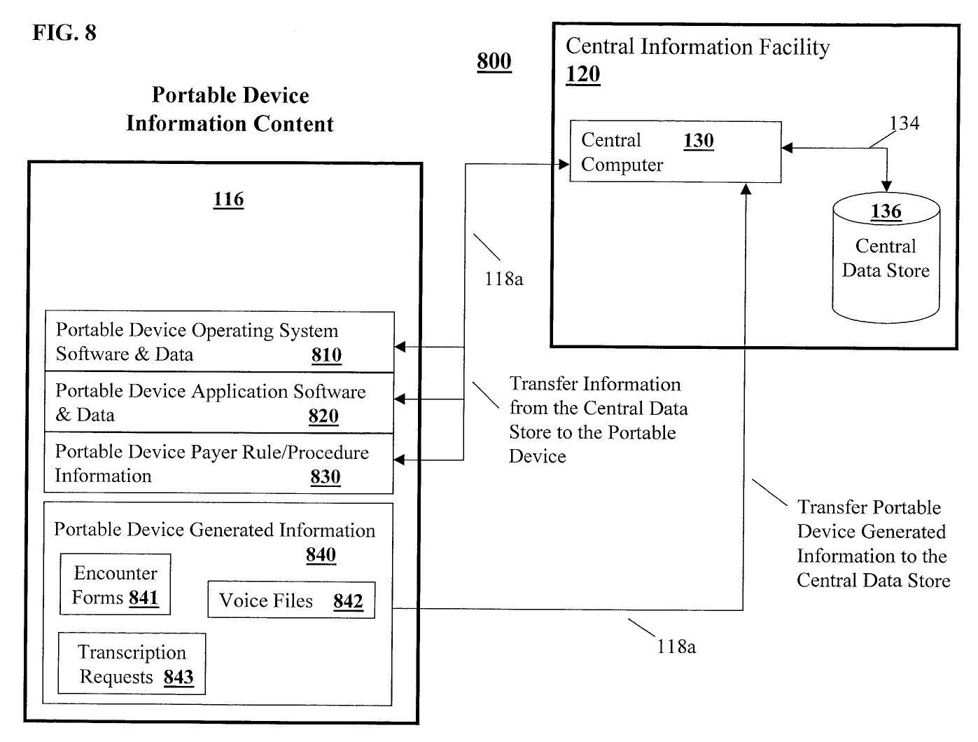

FIG. 8 illustrates some of the information stored in the memory 336 and 340 of the portable device 116. Practically, all of the herein described information is stored in read-write (RAM) memory 340. The portable device 116, is not limited to storing encounter related information. The portable device 116 contains memory 340 for storing operating system software and data 810. This portion of memory can store for example, the Microsoft Windows CE or the Palm OS operating system software and data.

This memory 340 also stores the encounter software program and data 820. The encounter software program, as application software 820, directs the operating system software 810 to control the portable device hardware for facilitating a practitioner-patient encounter. Some application software data 810, although stored in read-write memory, is only read by application software 810. Read only data can include configuration or user preference parameterized information. This type of information enables the application software to be customized with respect to one or more entities. This type of customization can be with respect to a related entity, such as customized to the central information facility 120, to the health care facility 110a-n, or customized to a particular user 114b or 114c such as the practitioner etc.

The application software 820 generates information 840 in response to how the software 820 is exercised by the user 114b or 114c. This information 840 represents encounter activity, including information describing actions taken by the practitioner during or associated with practitioner-patient encounter. The source of some of the information processed into generated information 840 is selected or entered into the portable device 116 by the user 114b or 114b.

This generated information 240 can include the encounter forms 841, voice files 842 and transcription requests 843. An encounter form 841 is designed to include as sufficient information, including the association of the patient to a health care insurer or payer, to request payment approval from the health care payer. An encounter form 841 is provided to the billing service 140a-140n as sufficient information to generate and deliver a bill to the health care payer.

Encounter forms 841 can vary by specialty and health care facility (medical office). Encounter forms 841 can also be referred to as charge tickets, routing slips or superbills. Customized encounter forms 841 can be accommodated via associated software tools that can create customized forms 841. The billing service 140a-140n receives encounter forms 841 from the central computer 130 and formats at least a portion of the information contained in these forms 841 into an HCFA 1500 form which is mandated by Medicare and which is accepted by the majority of health insurance companies or payers for payment. The HCFA 1500 form applies to office visits and not hospital billing which uses a different form (UB 92).

Voice files capture voice information via a Dictaphone or microphone 332 and store practitioner-user 114b-114c comments regarding subject matter associated with the encounter. A transcription request contains textual and/or numeric information that associates each voice file with the subject matter that the practitioner-user 114b-114c voice file comments are directed towards.

The portable device memory 340 provides storage for health care insurer or payer specific rule and procedure information 830. This information is communicated from the central data store 136 via the central computer 130 and optionally via the health facility computer 112a.

This information 830 is processed by the application software program to enforce compliance with health care payer rules and procedures during the practitioner-patient encounter. The program 820 reads and processes payer specific rule and procedure data at appropriate times during the execution of the program 820. For example, payer specific rules are processed when the user 114b-c selects a drug or procedure after selecting a diagnosis. The relationship between all 3 selections, the selected diagnosis, the selected drug-medication and the selected medical procedure is checked for compliance with the procedures or rules encoded into the payer rule/procedure information 830, specified by the associated health care payer for the patient.

The application software 820 provides an interactive user interface that notifies the practitioner-user 114b-114c of actions that are not consistent with the patient associated health care payer rules required for payer policy compliance, affiliation or payment approval. The application software 820, can also notify and sequentially prompt the practitioner-user 114b-114c, via the use of a series of popup windows, to take actions to satisfy rules and complete procedures required for payer policy compliance, affiliation or payment approval. Each popup window can identify and describe an action that the practitioner-user 114b-144c represents as complete by communicating information to the popup window, for example via text entry, or a button selection. Information communicated to the popup window can constitute the popup window described action or represent that such an action was performed.

All the above described information 810, 820, 830 and 840 is communicated to the portable device 116 from the central data store 136 via the central computer 130 and optionally via the health care facility computer 110a-110n (not shown). The application software and data 830 will typically be communicated at times and frequencies due to application software version availability or configuration changes. The health care payer rule/procedure information 830 will typically be communicated at times and frequencies in response to health care payer rule/procedure changes. The operating system software and data 810 will typically be communicated at times and frequencies based upon availability of operating system software version updates.

Application software generated encounter forms 841 would be communicated from the device 116 to the central data store 136 via the health care facility computer 112a-n (not shown) and via central computer 130a-n at times a frequencies appropriate to administer billing and transcription activity. This would typically be communicated at least every 24 hours, preferably after the end of the work day and before the start of the next work day. For example, at 11:00 PM each work day evening.

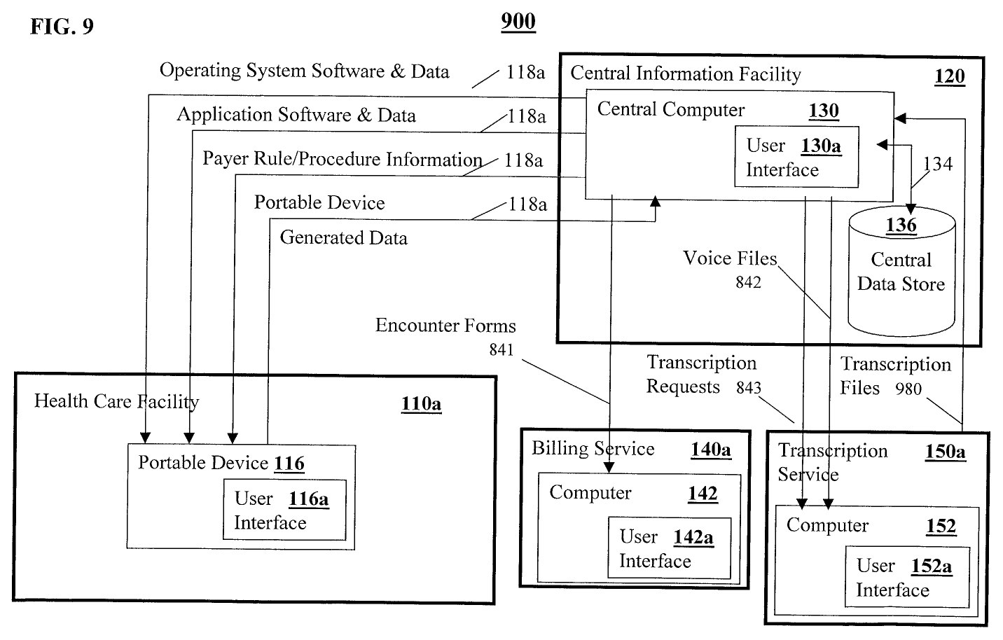

Referring to FIG. 9, as discussed in FIG. 8, the portable device generated information 240 can be transferred to the central data store 136 via the health care facility computer 112a-n (not shown) and the central computer 130. From the central data store 136, the encounter form can be further processed by a checker program 1032 and communicated to an appropriate or designated billing service 140a-n that is associated with the health care payer. In response, the billing service 140a-n will generate a bill to the health care payer for charges associated with the practitioner-patient encounter as indicated by the encounter form 841. In some embodiments, the billing service has secure Internet access to all checker program processed encounter forms it is designated to process. The billing service 140a-n can be notified when newly processed encounter forms 841 are available in the data store 136 and will be able to view, print and process the encounter forms 841 to generate a payment request or bill to the payer associated with the encounter form 841.

Likewise, voice files 842 stored by the application software 820 in association the encounter, and transcription requests generated by the device for each voice file, can be communicated to the central computer 130 via the health care facility computer 112 (not shown). From the central computer 130, the voice files and the associated transcription requests can be communicated to a designated translation service 150a-n. Such a designation can be determined by the policy of the central information facility 120, the health care facility 110a-n or as preferred by the practitioner 114b.

In one embodiment, both the billing service 140a-n access the encounter forms and the transcription services 150a-n access the transcription requests via the Internet. An Internet Web site (not shown) is provided by the central health care information facility computer 130. Both types of services have authorized users who must be authenticated when accessing the Web site.

In one embodiment, device generated information can include the identification of new patients and new appointments, or for example walk-n patients. This information can be added via the portable device user interface (not shown). Such device generated information would be communicated to the data store. Software tools, for example Active Sync 3.1 provided by Parkstone Medical Information Systems, Inc is designed to synchronize data between the hand held device and the data store 136 to promote the most up-to date storage of information on the central computer 130 or data store. This enables later downloads of information, such as software and data to the hand held device to contain recently uploaded information from the portable device 116a.

FIG. 10 illustrates information stored inside the central data store 136 and the operation of the checker program 1032 which executes on the central computer 130 to process and verify consistency and compliance between the portable device generated information 840 and payer rule/procedure information 830 residing inside the data store 136.

This data store 136 contains large amounts of memory storage, for example arrays of hard disks, for storing one or more versions of portable device operating system software 810, one or more versions of application software 820 and multiple versions of health care payer rule/procedure information 830.

Multiple versions of operating system software 810 are stored for support of a particular type of device 116, or for support of multiple device types, such as for supporting Casio and Palm manufactured hand held devices. Multiple versions of operating system software 810 for a particular type of device 116 can be stored, for example when unexpected defects are found in newly released operating system software versions. The system administrator 133 can opt to delay widespread installation of a newer version until it is sufficiently tested, or opt to re-install an earlier more predictable/reliable version over a newer less predictable/reliable operating system software version when defects in a newer version are discovered after installation. The system administrator can opt to re-install the earlier more predictable or reliable application software version replacing the newer less predictable or less reliable application version.

The data store 136 also stores one or more versions of the application software 820 for similar reasons as for operating system software 810. Multiple versions of application software 810 are stored for support of a particular type of device 116, or for support of multiple device types, such as for supporting Casio and Palm manufactured hand held devices, or for supporting different versions of operating system software 810 resident on those devices 116a-n. Multiple versions of application software 810 for a particular type of device 116 can be stored, for example to test new versions of the application software 820 or when unexpected defects are discovered in newly released application software versions. The system administrator 133 can opt to delay widespread installation of a newer version until it is sufficiently tested, or opt to re-install an earlier more predictable/reliable version over a newer less predictable/reliable version of application software when defects in a newer version are discovered after installation.

The data store 136 can also store one or more versions of the configuration data (not shown) resident inside the application software 820 for similar reasons as for the application software 820. The behavior of the application software can be adjusted simply by modifying configuration data processed by the software 820 Multiple versions of configuration data can be customized for each user 114b-114c, each health care facility 110a-110n or for the central information facility 120. Backup versions of configuration data for each type of entity, for example a user 114b-114 or health care facility can also be stored here.

Multiple versions of rule/procedure information 830 are stored for support of multiple sources of rules/procedures, such as from Medicare 1081, from specific health insurers or payers 1082a-1082n or from the health care facilities 110a-110n. Multiple versions of rule/procedure data can also be stored for each source entity. This can be useful to ensure that older records, such as older portable device generated information 840 have matching rule/procedure data for complete and consistent historical archiving.

Like the application software 820, the checking program 1032 is designed to process portable device generated information 840 and payer rule/procedure information 830 inside the data store 136, to verify health care payer policy compliance, affiliation or payment approval. The checking program 1032 executes on the central computer 130 while inter-operating with the central computer operating system 1031 via an operating system applications programming interface (API) 1033. The checking program can act operate to verify the correct operation of various installed versions of the application software or to perform compliance and consistency checks outside the scope of some or all installed versions of the application software 820. Some consistency or compliance checks may be too complicated or time consuming for the device to perform without interfering with the efficient interaction between the practitioner-user 114b-114c and the patient 114a during the encounter.

Problems found by the checker program 1032 can be corrected with central computer resident software tools (not shown) before access to encounter forms 841 by billing services 140a-140n or to voice 842 and transcription requests 843 transcription services 150a-150n.

Although the present invention has been described and illustrated in detail, it is clearly understood that the same is by way of illustration and example only and is not to be taken by way of limitation of the spirit and scope of the present invention.

1. A system for facilitating compliance with rules and procedures required for payment approval from a health care payer in connection with an encounter between a health care practitioner and a patient, comprising:
a portable device for use at a point of patient care by the health care practitioner, the portable device comprising:
a) memory for storing information that facilitates the health care practitioner's compliance with the rules and procedures required for payment approval from the health care payer in connection with the encounter;
b) an input mechanism for receiving input from a user at least during the encounter and at the point of care; and
c) an output mechanism for providing output to the user at least during the encounter and at the point of care.

2. The system of claim 1 wherein the portable device comprises a processor, wherein the information stored in the memory includes instructions for execution by the processor, and wherein the information also includes data that represents the rules and procedures required for payment approval from at least one health care payer in connection with the encounter.

3. The system of claim 2, wherein the portable device enables the user to communicate information to the device that specifies at least one diagnosis for the patient.

4. The system of claim 3, wherein the portable device enables the user to communicate information to the device that specifies at least one health care directive for the patient.

5. The system of claim 4, wherein the at least one health care directive for the patient includes at least one drug medication to be applied to the patient.

6. The system of claim 4, wherein the at least one health care directive for the patient includes at least one health care procedure to be applied to the patient.

7. The system of claim 4, wherein the device responds to the specified at least one health care directive by communicating information to the user that constitutes notice that the health care directive violates compliance with at least one rule or procedure required for payment approval by a health care payer in association with the encounter.

8. The system of claim 7, wherein the user communicates information to the portable device that constitutes at least a request for the portable device to calculate a visit level classification based upon the at least one diagnosis and the at least one health care directive.

9. The system of claim 2, wherein the user input mechanism of the portable device includes a voice input mechanism that enables capture and storage of voice information regarding at least one issue associated with the encounter.

10. The system of claim 9, wherein user communicates at least one portion of voice information to the device, and where the user communicates information that identifies at least one issue associated with the encounter, and where the user communicates information directing that the at least one portion of voice information be stored in association with the at least one issue.

11. The system of claim 2, wherein the user communicates information to the device that constitutes at least a query for identifying remaining actions required for compliance with rules and procedures required for payment approval by a health care payer in association with the encounter.

12. The system of claim 8, where in the device responds to the query by communicating at least one prompt to the user, the prompt communicating a directive for performing at least one action, and where the user responds to the at least one prompt by communicating information to the device representing or constituting the performance the at least one action.

13. The system of claim 1, where in the system further comprising:
a central information facility comprising:
a) a computer connected to the portable device via a first communications channel, the computer receiving information generated by the portable device in connection with the encounter;
b) a data store connected to the computer via a second communications channel, the data store receiving and storing information generated by the portable device in connection with the encounter.

14. A method for facilitating compliance with rules and procedures required for payment approval from a health care payer in connection with an encounter between a health care practitioner and a patient, comprising the steps of:
a) providing at least one portable device, the portable device for use at a point of patient care by the health care practitioner, the portable device comprising:
a memory for storing information that facilitates the health care practitioner's compliance with the rules and procedures required for payment approval from the health care payer in connection with the encounter
an input mechanism for receiving input from a user at least during the encounter and at the point of care; and
an output mechanism for providing output to the user at least during the encounter and at the point of care.

15. A method for facilitating compliance with rules and procedures required for payment approval from a health care payer in connection with an encounter between a health care practitioner and a patient, comprising:
a) receiving via a first communications channel, information generated by at least one portable device in connection with the encounter;
b) storing the information generated by at least one portable device in connection with the encounter.

16. A method for facilitating compliance with rules and procedures required for payment approval from a health care payer in connection with an encounter between a health care practitioner and a patient, comprising the steps of:
a) providing at least one portable device, the portable device for use at a point of patient care by the health care practitioner, the portable device comprising:
a memory for storing information that facilitates the health care practitioner's compliance with the rules and procedures required for payment approval from the health care payer in connection with the encounter
an input mechanism for receiving input from a user at least during the encounter and at the point of care; and
an output mechanism for providing output to the user at least during the encounter and at the point of care;
b) receiving via a first communications channel, information generated by the at least one portable device in connection with the encounter;
c) storing the information generated by the at least one portable device in connection with the encounter.
